(19) United States
(12) Patent Application Publication
(10) Pub. No.: US 2010/0057507 A1
(43) Pub. Date: Mar. 4, 2010

(54) Real-Time Manufacturing Routing Optimization Using Content and Quality Level

(75) Inventors: Carl J. Berberich, Rochester, MN (US); Kurt D. Knodel, Rochester, MN (US); Joel C. Poppen, Rochester, MN (US); Christopher M. Williams, Rochester, MN (US)

Correspondence Address: Marcia L. Doubet Law Office, P.O. Box 422859, Kissimmee, FL, 34742-2859, US

(73) Assignee: International Business Machines Corporation, Armonk, NY (US)

(21) Appl. No.: 12/202,193

(22) Filed: Aug. 29, 2008

(51) Int. Cl. G06F 9/44

(52) U.S. Cl. 705/7

(57) ABSTRACT

Dynamically generating manufacturing routings in a manufacturing environment, using content and quality level information. The content and quality level information may pertain to multiple, disparate commodities (e.g., parts and/or assemblies) which are to be processed as a group, and some of those commodities may have already undergone various processes (such as testing of various types and durations). The generated routings may reflect parameterizations pertaining to the commodities.

### BACKGROUND OF THE INVENTION

The present invention relates to manufacturing environments, and deals more particularly with using content and quality level to determine manufacturing routings.

A manufactured product may be comprised of a number of sub-products, which may alternatively be referred to simply as parts. A computer, for example, typically comprises various types of memory and storage hardware. In turn, the memory and/or storage hardware may be comprised of a number of smaller parts. A laptop computer may contain on the order of 30 to 40 parts, for example, whereas a large computer server may contain on the order of 30,000 to 40,000 parts. The term “assembly” is used herein to refer to a collection of more than one part. The term “sub-product” is used herein to refer to a part or assembly that is integrated with other parts or assemblies to build a product. For ease of reference, the term “commodity” is used herein to refer generally to parts and assemblies.

### BRIEF SUMMARY OF THE INVENTION

The present invention is directed to dynamically generating a routing specification for a plurality of commodities to be processed together. In one aspect, an embodiment of the present invention comprises: for each of the commodities, determining a current processing status thereof and using the determined current processing status and a commodity identifier associated with that one of the commodities to locate an associated routing definition, the associated routing definition specifying at least one process to be performed on that one of the commodities; optimizing a collection comprising the specification of the at least process from each of the associated routing definitions; and providing the optimized collection as the dynamically-generated routing specification for the plurality of commodities.

The commodities may comprise, for example, at least one part and/or at least one assembly comprising a plurality of parts. The current processing status may indicate, for each of the commodities, any processes that have already been conducted on that commodity. The optimization may comprise optimizing a frequency with which an associated routing definition is to be performed and/or argument values specified in an argument list for parameterizing an associated routing definition.

Embodiments of these and other aspects of the present invention may be provided as method, systems, and/or computer program products. It should be noted that the foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined by the appended claims, will become apparent in the non-limiting detailed description set forth below.

The present invention will be described with reference to the following drawings, in which like reference numbers denote the same element throughout.

### BRIEF DESCRIPTION OF THE SEVERAL VIEWS OF THE DRAWINGS

FIG. 1 illustrates a high-level view of commodity processing according to the prior art;

FIG. 2 illustrates a high-level of optimizing manufacturing routings during commodity processing according to an embodiment of the present invention;

FIGS. 3-6 provide sample data structures for storing routing definitions, commodity routing profiles, frequency optimization strategy information, and argument list optimization strategy information, respectively, for use with an embodiment of the present invention;

FIG. 7 provides a flowchart depicting logic which may be used when implementing an embodiment of the present invention;

FIGS. 8-13 provide sample data structures which are used to illustrate operation of FIG. 7;

FIG. 14 depicts a data processing system suitable for storing and/or executing program code; and

FIG. 15 depicts a representative networking environment in which one or more embodiments of the present invention may be used.

### DETAILED DESCRIPTION OF THE INVENTION

Embodiments of the present invention are directed toward dynamically generating manufacturing routings in a manufacturing environment, using content and quality level information. The content and quality level information may pertain to multiple, disparate commodities which are to be processed together, and some of those commodities may have undergone various processes. (References herein to manufacturing are to be construed as also including assembly.)

An example of the various processes that may be performed on commodities during manufacturing of an end product is testing. For example, testing may be conducted on the individual parts, and when parts are assembled into an assembly that will subsequently be used in a product, additional testing may be conducted on that assembly. An assembly might be installed into yet another assembly, and further tests may be conducted on that resulting assembly. A varying amount of time may pass before a particular commodity is taken from inventory for installation into a product. Some of these commodities may be returned to inventory for various reasons. An order for a product might be changed after the building of the product has already started, for example, requiring one commodity to be removed and another to be installed. Or, interim testing may indicate problems with an already-installed commodity, necessitating removal and replacement. Typically, when an assembly is removed, it is separated into its individual parts and restocked for later use.

In systems known to the present inventors, no consideration is made during assembly of a product for commodities that may have already undergone various processing, such as testing that was performed on the commodity when it was previously installed in another product. Instead, known systems repeat the processing that is called for at a particular point in the assembly process without regard to whether some, or all, of that processing is redundant with the previously-performed processing. For example, a particular part “A” may have been tested using a particular testing procedure “X” for 30 minutes when part A was installed into assembly “A1”. Suppose that assembly A1 is installed into another assembly “A2”. If the manufacturing process calls for testing assembly A2 using the testing procedure X for 60 minutes, known systems make no consideration for the 30 minutes of testing that has already been performed on part A. Similarly, if part A is removed from assembly A1 after the 30 minutes of testing and installed into another assembly “B1” that also needs 30 minutes of testing procedure X, no consideration is given to the already-performed testing on part A. In either scenario, this leads to inefficient use of manufacturing time and resources.

Known systems also fail to consider differing requirements of commodities processed as a group during manufacturing. One commodity “C” might need 3 hours of a particular testing procedure “Y”, for example, while a different commodity “D” requires only 1 hour of that procedure Y. And, commodity D might also require a subsequent testing procedure “Z” whereas commodity C does not require testing procedure Z. Due to space and/or financial constraints, however, commodities are often combined together into groups for undergoing processes such as testing. According to common industry practice, a static routing is created where the processing requirements for a group of disparate commodities are determined by taking a union of the processing requirements of each commodity in the group. While this allows for combined processing, it is not optimized. Consider a simple example where a group comprises 100 of the above-described commodity C and 12 of the above-described commodity D. Using this known approach, the group would undergo a total of 4 hours of testing procedure Y (i.e., 3 hours according to the requirements of the commodity C and 1 hour according to the requirements of the commodity D) and all of these parts would then undergo the subsequent testing procedure Z (even though this test is not required for the commodity C). As demonstrated by this simple example, this known approach leads to inefficient use of manufacturing time and resources.

The present inventors know of no solution that optimizes processing by considering previously-performed processing or that optimizes processing requirements in a group of multiple, disparate commodities. An embodiment of the present invention, by contrast, addresses these issues.

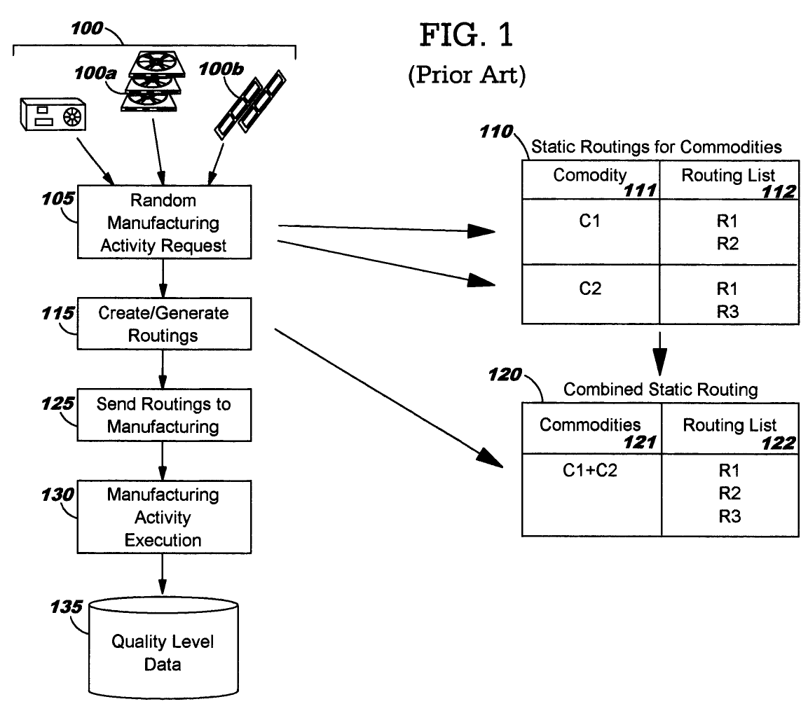

FIG. 1 illustrates a current industry approach, whereby an activity request may be received for a random collection of parts and/or assemblies 100; see Block 105. An operator may receive a collection of various commodities, for example, and may be requested to carry out the needed processing on the group. Three different types of commodities are illustrated at 100 in FIG. 1, although for ease of reference, only two of those commodity types are discussed with regard to the further processing in FIG. 1.

The current industry approach determines the further processing for the collection of commodities using static routing information for the individual commodities, and generates a combined static routing for the collection. See Block 115. A “routing”, “routing definition”, or “routing list”, as those terms are used herein, refers to a specification of the operations or steps to be performed as a commodity or group of commodities is routed through the manufacturing process. The static routing information used at Block 115 may come from a material requirements planning (“MRP”) system, from an application program, and so forth. In FIG. 1, a sample table 110 of static routings is shown, illustrating one manner in which the static routing for each commodity may be obtained.

The sample table 110 is indexed by a commodity identifier; see column 111. Each entry in the sample table 110 also contains a routing list; see column 112. This routing list specifies a list of the processing that is to be performed on instances of this commodity. For example, suppose that commodity identifier “C1” refers to the disk drives shown at reference number 100a and that commodity identifier “C2” refers to the memory elements shown at reference number 100b. The first row of sample table 110 indicates that the 3 instances of commodity C1 are each to undergo a test “R1” followed by a test “R2”. The second row of sample table 110 indicates that the 2 instances of commodity C2 are each to undergo the same test R1 followed by a test “R3”.

Table 120 shows a sample output of Block 115, namely a combined static routing for the collection of components C1 and C2. In this sample table 120, the left column 121 identifies the grouped commodities and the right column 122 lists the processing that is to be performed on the commodities in this group. For the sample data shown in FIG. 1, the group comprising commodities C1 and C2 is to undergo 3 tests, namely tests R1, R2, and R3, where these test identifiers are retrieved from the entries in column 112 of the rows of table 100 that correspond to commodities C1 and C2. (Using the current industry approach, the combined static routing would also include the static routings pertaining to the other components from the collection 100, although these additional routings are not illustrated in tables 110 and 120 for ease of illustration.)

The combined static routings are then sent to manufacturing (Block 125), where the specified processes are carried out (Block 130) on the commodities.

In some known systems, quality level data is recorded, as shown at 135, indicating the processing that has been performed at Block 130 for each of the commodities. This quality level data may be recorded at a serial number level within each part number or assembly number, thereby uniquely identifying the processing that has been performed on a particular commodity (i.e., on an individual part or assembly). Commonly-assigned U.S. patent application Ser. No. 11/612,981, which is titled “Method and System for Associating Objects in a Manufacturing Process” and which is referred to hereinafter as “the associations application”, discloses techniques which may be used for this quality level data recording.

The current industry approach shown in FIG. 1 is not optimized, however. No consideration is given to whether C1 and C2 have been processed earlier. For example, if individual instances of C1 were previously sent through a manufacturing process, the R1 and R2 tests may have already been fully or partially performed on those instances. The current industry approach fails to consider that, however, and will perform the processing in combined static routing table 120 in its entirety. And, even where the commodities have not undergone processing, the current industry approach fails to optimize. Suppose, for purposes of illustration, that the tests R1, R2, and R3 comprise an initial program load (“IPL”) verification, a 120-minute test, and a 60-minute test, respectively, and that the R2 and R3 tests are the same type of test and vary only in duration. The current industry approach generates the combined static routing as a union of the static routing for all commodities in the collection. Accordingly, column 122 of the combined static routing table 120 lists the R1 IPL verification, the 120-minute R2 test, and the 60-minute R3 test. When this combined static routing is executed at Block 130, the commodities C1 and C3 will undergo 180 minutes of testing, even though (in this example) the 60-minute R3 test is fully encompassed by the 120-minute R2 test.

An embodiment of the present invention addresses the above-described inefficiencies of known systems and current industry practice, dynamically determining routings using quality information that indicates previously-performed processing for each commodity and considering requirements of possibly-disparate commodities that have been grouped. (Note, however, that an alternative embodiment of the present invention may address a single one of these two aspects, and such alternative embodiment is deemed to be within the scope of the present invention.)

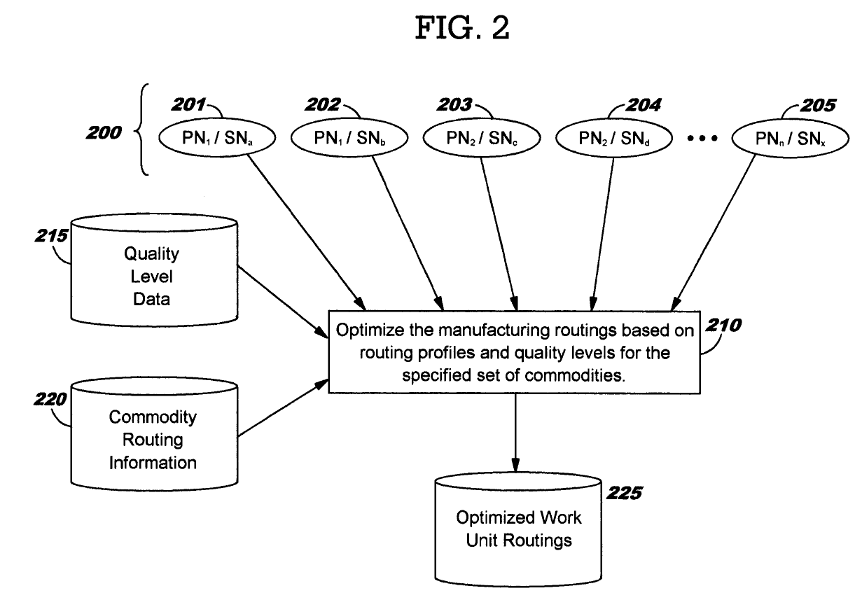

FIG. 2 illustrates a high-level view of processing according to an embodiment of the present invention, illustrating optimizing of manufacturing routings during commodity processing. A collection 200 of commodities is to be processed together (responsive, by way of example, to a random manufacturing activity request as depicted at 105 in FIG. 1), and the collection is depicted by reference numbers 201-205 in this example. Suppose that commodities 201 and 202 are instances of the same part number “PN₁”, although each instance (shown in FIG. 2 as having different serial numbers “SNₐ” and “SN_{b}”, respectively,) has already undergone a different level of processing. The first part 201 might be a new part which has not had any processing performed, for example, while part 202 might have undergone testing while installed into an assembly from which it has now been removed. Commodities 203 and 204 are illustrated as instances of the same part number “PN₂”, and each has a different serial number and the processing that has been performed on these two instance may be different. A particular collection of commodities may include many different types of commodities (i.e., commodities having different part/assembly numbers), and the collection may include different numbers of instances thereof

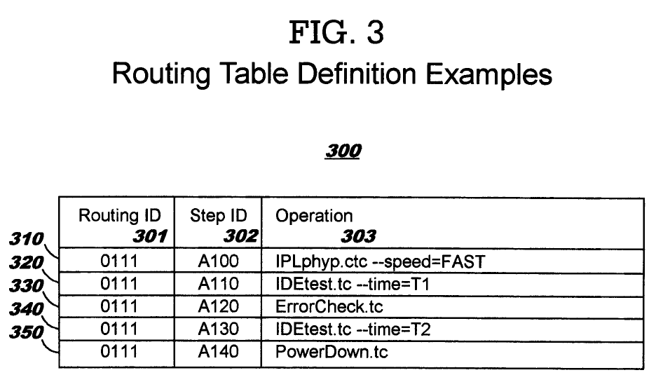

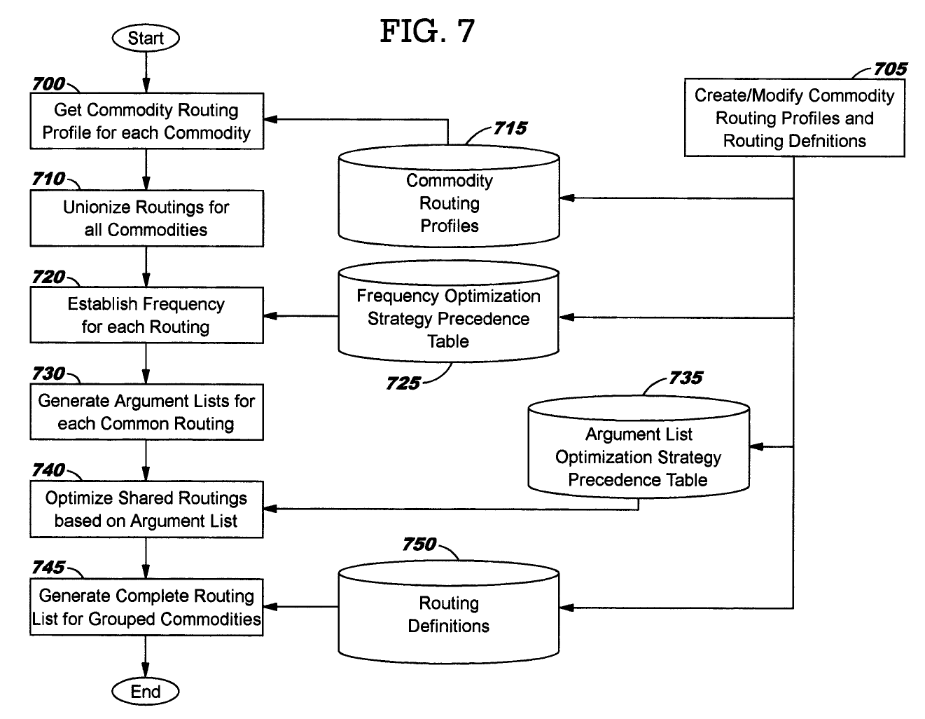

Leveraging the quality level data as recorded, for example, by an implementation of the associations application, the already-performed processing for each commodity may be used as input to a dynamic routing generator 210. See quality level repository 215, from which this information may be obtained. An additional input to dynamic routing generator 210 comprises, in an embodiment of the present invention, commodity routing information 220. This commodity routing information discussed in more detail below, with reference to sample data in FIGS. 3-6 (and the processing thereof is discussed with reference to FIGS. 7-13). The dynamic routing generator 210 creates, as an output 225, optimized work unit routings. (A “work unit”, as that term is used herein, is a batch or work group comprising commodities to be processed together.)

It should be noted that while manufacturing processes and routings are discussed herein with reference to testing, this is by way of illustration and not of limitation. Other types of processes may be specified in addition, or instead, in a routing.

An embodiment of the present invention may use information stored in several data structures. The data structures are referred to herein as using tables. This is by way of illustration and not of limitation, however, and an alternative embodiment may use data structures which are not represented as tables. Furthermore, an embodiment of the present invention is not limited to the particular data structures or formats shown herein; alternatively, an embodiment of the present invention may use more, fewer, or different data structures, and the format of those data structures may be different from that shown herein. Four data structures that may be used as input by an embodiment of the present invention will now be described with reference to FIGS. 3-6 (and optionally, an embodiment of the present invention may include an editor or other tool that allows a user to create entries in these data structures and that validates such entries for syntactical correctness).

Referring now to FIG. 3, a first of the sample data structures that stores routing definitions is illustrated, along with sample data. A particular routing may comprise a single processing step, or a sequence of multiple processing steps. A particular routing definition may be reused for multiple commodities that each require that type, and sequence, of processing.

As shown in FIG. 3, a routing definition may comprise the following information: a routing identifier 301; a step identifier 302; and an operation 303. Each of these will now be described.

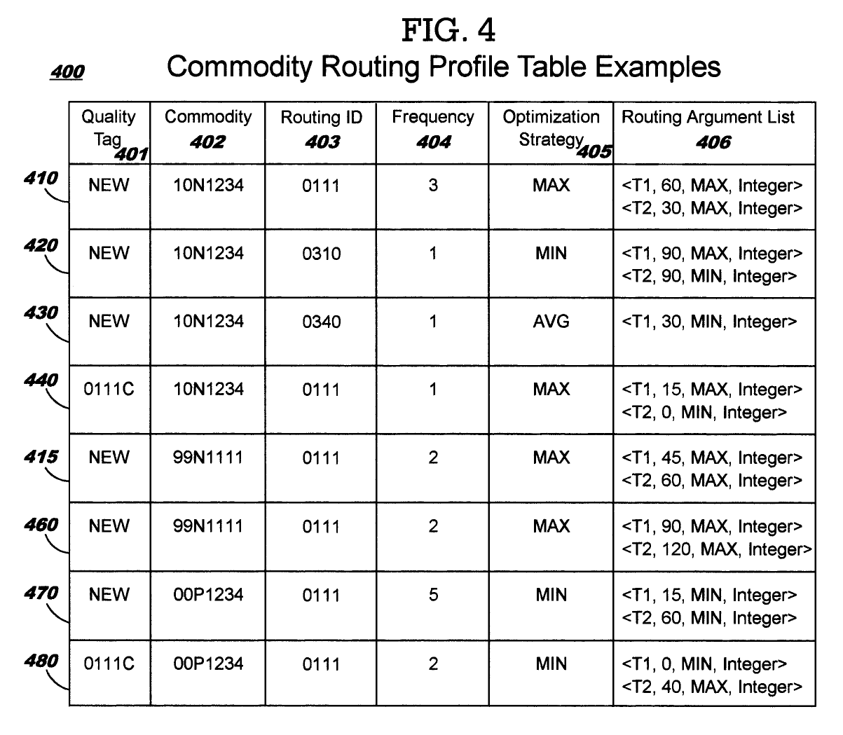

Routing identifier 301 may be a string or integer value. Repeating a single routing identifier value in multiple rows of routing definition table 300 indicates that the operation in each of those rows is one of the steps of the routing which is defined by that routing identifier. The routing identifier may also be used to correlate to one or more commodity routing profiles (examples of which are provided in the sample commodity routing profile table 400 of FIG. 4; see column 403 thereof), and these commodity routing profiles may pertain to disparate commodities.

Step identifier 302 may be an integer or string value, and is unique within the scope of a particular routing identifier. The step identifier therefore uniquely identifies a particular step, or operation, in the processing associated with that routing identifier. The step identifier may be manually or programmatically assigned.

Operation 303 is preferably a string value that specifies some type of manufacturing process operation to be performed on a commodity. The particular syntax used for specifying an operation may vary without deviating from the scope of the present invention. An embodiment of the present invention preferably uses a syntax, however, that supports variables (also referred to herein as “arguments”) to enable parameterization of the steps. Values for these variables are propagated during optimization phases, as discussed below with reference to Block 745 of FIG. 7.

The sample data in table 300 specifies a single routing definition having identifier “0111” and containing 5 steps, each step being defined in one of the 5 rows 310-350 of table 300. The first step (identified in column 302 of row 310 as step “A100”) specifies that an operation “IPLphyp.ctc” is to be performed. See column 303 of row 310. In the sample syntax used herein, a notation “−” followed by a string indicates presence of a parameter or argument specification. (The terms “parameter” and “argument” are used interchangeably herein.) In row 310, the argument specification is “speed=FAST”. For purposes of illustration, this may be considered as assignment of a statically-assigned parameter value (and dynamically-assigned parameter values are discussed with reference to row 320). That is, it may be presumed that the “speed” parameter indicates a speed to be used in the “IPLphyp.ctc” operation, and in this sample data, the parameter value for the “speed” parameter is specified as “FAST”. (Parameter values may be communicated to operations in various ways, without deviating from the scope of the present invention. For example, an operator might activate a switch associated with a fast speed for performing the operation in row 310, or might select a choice representing this parameter value from a graphical user interface.)

In the second step of this routing definition 0111 (identified in column 302 of row 320 as step “A200”), an operation “IDEtest.tc” is to be performed. See column 303 of row 320. This operation uses a dynamically-assigned parameter value, according to an argument value propagation feature supported by an embodiment of the present invention. In this sample data, the parameter name is “time” and the parameter value is specified in row 320 as “T1”. This string T1 is used as a variable (as can be determined, for example, by reference to the routing argument list column 406 of FIG. 4, which is discussed below). This allows the routing definition to be flexibly reused and to be customized dynamically (i.e., when different routings specify different values for the argument). A value for the T1 argument is propagated from a routing argument list associated with a particular commodity during run-time processing, as will be discussed in more detail below with reference to Block 745 of FIG. 7.

Row 340 specifies a step “A130” having a parameter “T2”, and this parameter is processed in a manner similar to the T1 parameter. The steps “A120” and “A140” defined in rows 330 and 350, respectively, do not use parameters in this example.

Referring now to FIG. 4, a second of the sample data structures that stores commodity routing profiles is illustrated, along with sample data. A commodity routing profile is associated with a particular commodity, and specifies a routing identifier to correlate that commodity with at least one processing requirement (i.e., with at least one processing step, as defined in the routing definition to which the routing identifier corresponds).

As shown in FIG. 4, a commodity routing profile may comprise the following information: a quality tag 401; a commodity identifier 402; a routing identifier 403; a frequency value 404; an optimization strategy 405; and a routing argument list 406. Each of these will now be described.

Quality tag 401 is preferably an identifier signifying the degree of processing which has already been conducted on a commodity, if any, and may be referred to more generally as the current processing status of the commodity. The serial number of a particular commodity instance may be used to retrieve its quality tag from a quality level data repository (as illustrated at 215 of FIG. 2), where the quality level data (including the quality tag) stored therein may be generated by an embodiment of the associations application. For example, quality tag “0111C” (see rows 440 and 480 of table 400) might indicate “routing 0111 is completed”.

Commodity identifier 402 is preferably an identifier, such as a part number or assembly number, which identifies a type or family of commodity. As one alternative, the commodity identifier 402 may be a textual description, such as “4 G memory disk”.

Routing identifier 403 is preferably an identifier that correlates to a group of entries in the routing definition table, an example of which is provided in FIG. 3; see column 301 (which, in this sample data, correlates to the routing identifier in rows 410 and 440-480 of table 400).

Frequency value 404 is preferably an integer that indicates how many times the routing identified by the routing identifier in column 403 should be executed for a given type of commodity. In the sample data, the routing associated with routing identifier 0111 is to be performed 3 times for a commodity corresponding to row 410, but only 1 time for a commodity corresponding to row 440 (which presumably indicates that a commodity corresponding to row 440 has already undergone some of this processing) and so forth.

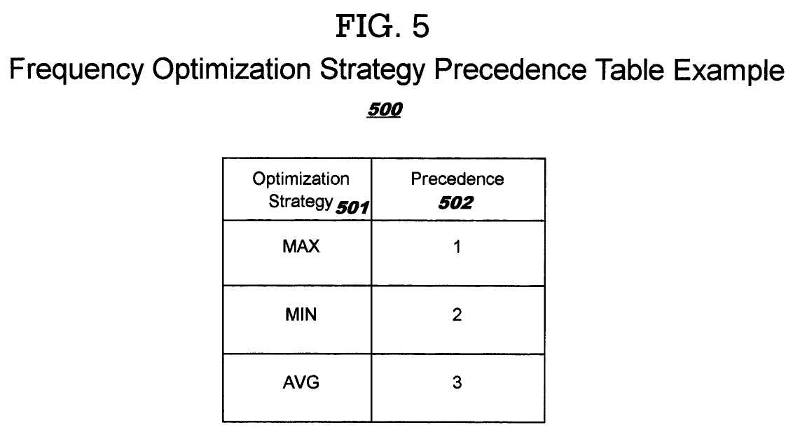

Optimization strategy 405 is specified, according to an embodiment of the present invention, as a value from predetermined list, and these values correspond to entries in frequency optimization strategy table 500 of FIG. 5 (discussed below). In the sample data, the predetermined values comprise “MAX”, “MIN”, and “AVG”. An embodiment of the present invention may apply the optimization strategy value from column 405 when performing a frequency optimization for a routing list (as will be described with reference to Block 720 of FIG. 7).

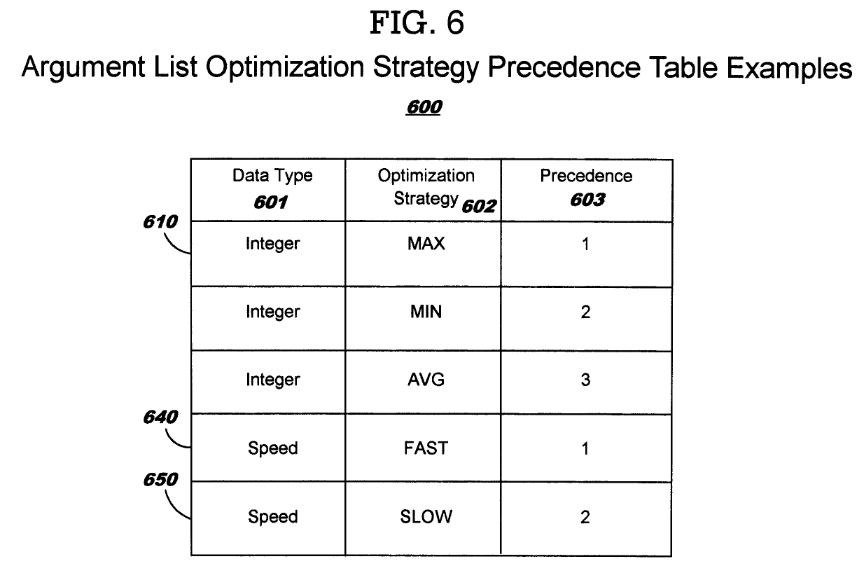

Routing argument list 406 comprises, according to an embodiment of the present invention, an argument list (which may alternatively be referred to as a tuple) of the form <key, value, strategy, type> that enables a routing to be parameterized. Entries in a particular routing argument list indicate what variables are configurable within a routing definition, and what values are to be used in that routing definition for a particular scenario. Referring by way of example to the first row 410 of table 400, two routing argument lists are specified in column 406, indicating that two different parameterizations may be applied to the routing identified in column 403 (as has been discussed above with reference to rows 320 and 330 of routing definition table 300). The first of these tuples is illustrated as <T1, 60, MAX, Integer>. This is interpreted, according to an embodiment of the present invention, as specifying that a parameter named “T1” is to use a value of “60”, and that conflicts (if any) pertaining to the T1 parameter are to be resolved using a keyword of“MAX” as an index to a resolution strategy for a data type of“Integer”. (Conflicts may occur if multiple disparate commodities specify different values in the argument list for a particular routing that is referenced by the routing definition of more than one of the commodities, as will be described below with reference to the argument list optimization strategy table 600 of FIG. 6 and Block 740 of FIG. 7.)

The variables using in a routing argument list may be of generally any data type, provided a corresponding optimization strategy for that data type is defined. When creating an entry in the commodity routing profile table 400, the strategy element of the routing argument list (i.e., the third position in the tuple) should use a similar data type for each similar key element (i.e., the first position in the tuple), thus facilitating an algorithmic resolution of conflicts. For example, if one tuple specifies T1 as the key and MAX as the strategy, where the optimization strategy compares numeric values (such as 60 from the second position in the tuple), another tuple should not specify T1 as the key and then specify a strategy (such as “COLOR” or “SPEED”) for which the resolution algorithm uses a non-numeric approach.

Entries in the commodity routing table 400 are preferably indexed using two values, namely the quality tag 401 and the commodity identifier 402. By specifying a particular quality tag and commodity identifier as the table index, a row or rows is/are retrieved from the table, and the retrieved information is used to define a routing block for the commodity in question. A “routing block” is a sequence of one or more operations that are to be performed on a commodity, where these operations may be defined in multiple routing definitions. For example, if a quality tag value of “NEW” and a commodity identifier value of “10N1234” are used as the index to table 400, rows 410-430 will be retrieved. These 3 rows correspond to 3 different routings (see column 403), and the resulting routing block will then be determined (as discussed in more detail with reference to FIG. 7) using the routing definitions for each of these 3 routings.

The sample data in table 400 pertains to 3 different types of commodity. The first commodity type has identifier “10N1234”, and rows 410-440 of table 400 specify routing profiles for this commodity type. The second commodity type has identifier “99N1111”, and the rows 450-460 of table 400 specify routing profiles for this commodity type. The third commodity type has identifier “00P1234”, and rows 470-480 of table 400 specify routing profiles for this commodity type. Table 400 illustrates use of 2 different quality tags, namely “NEW” and “0111C’. The quality tag value of“NEW” may be used, for example, as a keyword to indicate that this routing profile is to be used for the specified commodity 402 when no processing has been performed for an instance of this commodity. Accordingly, rows 410, 420, 430 specify routing profiles for instances of commodity type “10N1234” which have not yet been processed, whereas row 440 specifies a routing profile for instances of this commodity type which have already reached some processing point identified using the quality tag “0111C”.

Referring now to FIG. 5, a third of the sample data structures that stores frequency optimization strategy information, including frequency optimization precedence values, is illustrated, along with sample data. The frequency optimization strategy precedence table defines a common precedence for various frequency optimization strategies, and will be referenced by an embodiment of the present invention when optimizing routings for multiple commodities that each have their own frequency (as discussed below with reference to Block 720 of FIG. 7). In other words, when a particular routing definition is referenced multiple times within a group of commodities, this table may be used to resolve a conflict between the frequency values specified in column 404 of table 400 by using the precedence value from table 500.

As shown in FIG. 5, a frequency optimization strategy definition may comprise a frequency optimization strategy 501 and a precedence 502. Each of these will now be described.

In this sample table 500, a frequency optimization strategy 501 may comprise one of a predetermined set of values. In the sample data, the set comprises 3 values, namely “MAX”, “MIN”, and “AVG”. See the optimization strategy column 501. The values in column 501 map to values from column 404 of table 400, and are used to locate the corresponding precedence value in column 502. (The 3 values used in column 501 are provided by way of illustration but not of limitation.)

Each of the frequency optimization strategy values in column 501 is assigned a corresponding precedence; see column 502. In the sample data, the precedence values 502 are sequentially-increasing integers, thereby indicating which optimization strategy takes higher precedence in the event of a conflict between multiple commodities. The discussions herein of using these precedence values presume that a highest precedence corresponds to the precedence value with the lowest number. Row 510 therefore indicates that “MAX” is the highest-precedence optimization strategy for frequency optimization. An embodiment of the present invention preferably allows the precedence values 502 to be modified by a user.

Referring now to FIG. 6, a fourth of the sample data structures that stores argument list optimization strategy information, including precedence values, is illustrated, along with sample data. Similar to the frequency optimization strategy precedence table 500 illustrated in FIG. 5, an argument list optimization strategy table may be used by an embodiment of the present invention for resolving conflicts when optimizing a routing block that is to be used for processing more than one commodity. More particularly, the argument list optimization strategy table defines a precedence for resolving conflicts in arguments within routing argument lists (see column 406 of table 400), as discussed below with reference to Block 740 of FIG. 7.

As shown in FIG. 6, an argument list optimization strategy may comprise the following information: a data type 601; an optimization strategy keyword 602; and a precedence value 603. Each of these will now be described.

Data type 601 is an identifier, defined by a user, which describes the value being optimized. Sample table 600 specifies 3 rows for an “Integer” data type and 2 rows for a “speed” data type.

Optimization strategy keyword 602 is preferably a user-selected value. The values in column 602 map to values within the routing argument lists (see column 406 of table 400), and are used to locate the corresponding precedence value in column 603. (The values used in column 602 are provided by way of illustration but not of limitation.) For example, when the data type is “speed”, the optimization strategy choices are shown in FIG. 6 as “FAST” and “SLOW”, and the FAST choice has a higher precedence than the SLOW choice. See rows 640 and 650, respectively. Definition of the optimization strategy itself is beyond the scope of the present invention, and may include invoking an algorithm that chooses a data value for resolving a particular conflict, using any type of processing that is relevant and applicable to the data being optimized.

Precedence 603 is preferably a sequentially-increasing integer value that is uniquely assigned within a particular data type to indicate which optimization strategy takes higher precedence for that data type in the event of a conflict between multiple components.

The sample data in table 600 specifies 2 different data types, as noted earlier, and each data type has its own unique set of optimization strategies and precedence values. For example, a highest precedence-associated with the integer 1, in the sample data—is associated with the optimization strategy “MAX” when the data type is Integer (see row 610) and when the data type is “Speed”, the highest precedence is associated with the optimization strategy “FAST” (see row 640).

FIG. 7 provides a flowchart depicting logic which may be used when implementing an embodiment of the present invention. This processing corresponds generally to the dynamic routing generator depicted at 210 of FIG. 2, and may be used, according to an embodiment of the present invention, to provide replacement processing for Block 115 of FIG. 1.

Block 700 obtains a commodity routing profile for each commodity that is to be processed together as a group. Preferably, the commodity routing profiles are obtained from a repository 715, and sample commodity routing profiles were described above with reference to FIG. 4. The commodity routing profiles, as well as the routing definitions discussed below (see reference number 750) are preferably created and/or maintained by personnel such as manufacturing engineers, production schedulers, parts planning personnel, and so forth, as indicated at reference number 705. A particular commodity routing profile may be created, for example, based on processing history. Output of Block 700 is a collection comprising separate routings for each of the commodities that is to be processed.

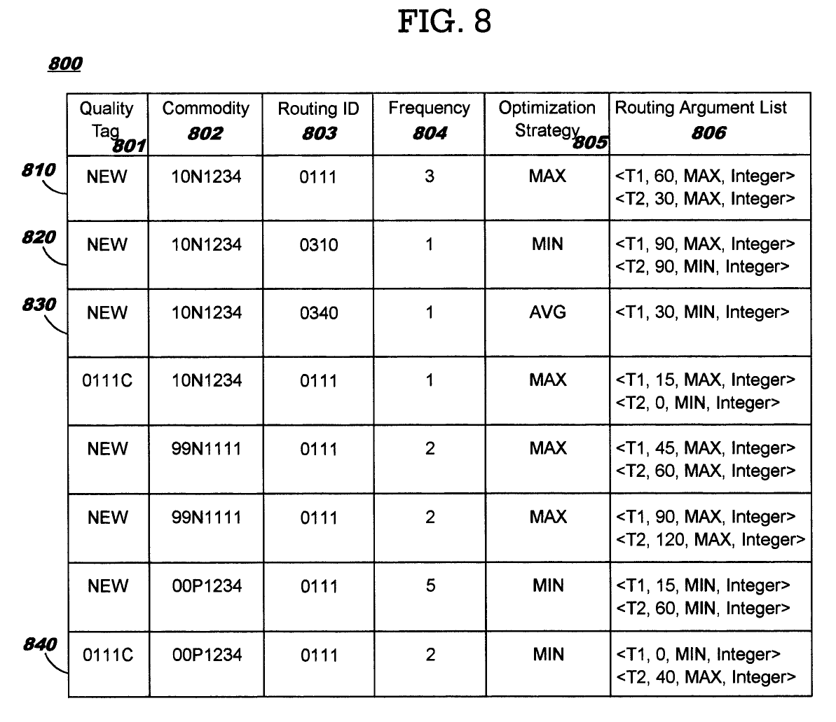

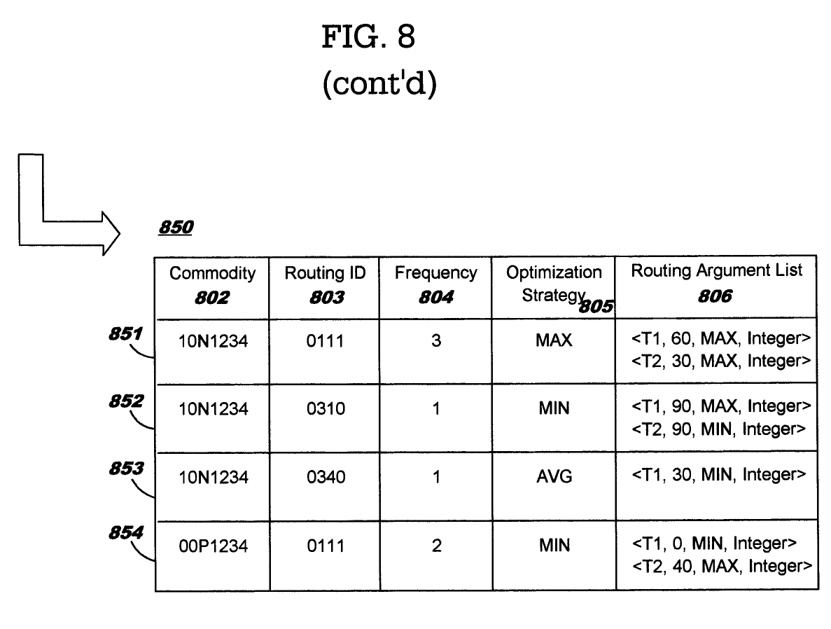

A sample scenario is discussed herein by way of illustrating the processing in FIG. 7, as will now be described with reference to the sample tables and content shown in FIGS. 8-13. Referring first to FIG. 8, the processing of Block 700 of FIG. 7 is illustrated therein. A sample input table 800 comprises a plurality of commodity routing profiles (and these sample commodity routing profiles correspond to sample data 400 of FIG. 4).

Suppose, for the sample scenario, that instances of 2 disparate commodities are to be processed as a group. The instances of a particular one of these commodity types may be referred to generally as a subgroup. The first commodity type has identifier “10N1234”, and the quality level data for all of the instances of this commodity type (i.e., the instances in the first subgroup) indicates that these instances have not yet received any processing; the corresponding quality tag value for these instances is therefore “NEW”. The second commodity type has identifier “00P1234”, and the quality level data for all of the instances of this commodity type (i.e., the instances in the second subgroup) indicates that these instances have undergone processing; the corresponding quality tag value for these instances, in the sample scenario, is “0111C”. (Two subgroups would also arise, in a different scenario, if the instances in the collection to be processed are all of the same commodity type but have two different quality tags, indicating that the instances have undergone two different types or degrees of processing.) Using these quality tag and commodity identifiers, Block 700 of FIG. 7 locates rows 810, 820, 830 of table 800 for the first commodity type and row 840 of table 800 for the second commodity type. An interim data structure containing portions of these retrieved rows is shown at 850 in FIG. 8. In the approach shown in FIG. 8, columns 802-806 of table 800 have been copied to corresponding columns of the interim data structure 850 (and the quality tag column 801 may be omitted from this interim data structure 850).

Block 710 of FIG. 7 then performs a unionization of the routings for all of the commodities that are to be processed together. An output of Block 710 is a set of routings for all of the commodities that are to be processed together, indicating all of the routings that are necessary for processing these commodities, according to their corresponding routing definitions.

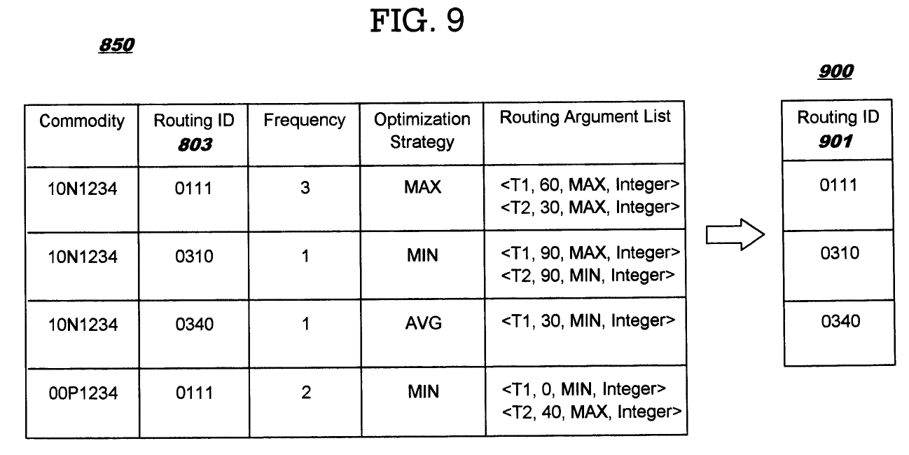

FIG. 9 illustrates the processing of Block 710. The interim data structure 850 from FIG. 8 is shown in FIG. 9 as an input for the processing of Block 710, and another data structure 900 is shown as an output. Table 900 comprises a collection of routing identifiers 901, representing each distinct one of the values from column 803 of interim data structure 850. In this sample data, a duplicated value “0111” appears in column 803, and thus the output data structure 900 contains only one occurrence of 0111 due to the unionization operation of Block 710.

Block 720 uses, as input, the set of routings created by Block 710 as well as the frequency optimization strategy precedence table depicted at 725 of FIG. 7 (an example of which was discussed above with reference to FIG. 5). Block 720 also uses the routings for the commodities, as created by Block 700, as an input. Using these inputs, Block 720 establishes a frequency for each of the routings that are to be performed, thereby creating a routing list, with corresponding routing frequencies, in which frequency conflicts have been resolved.

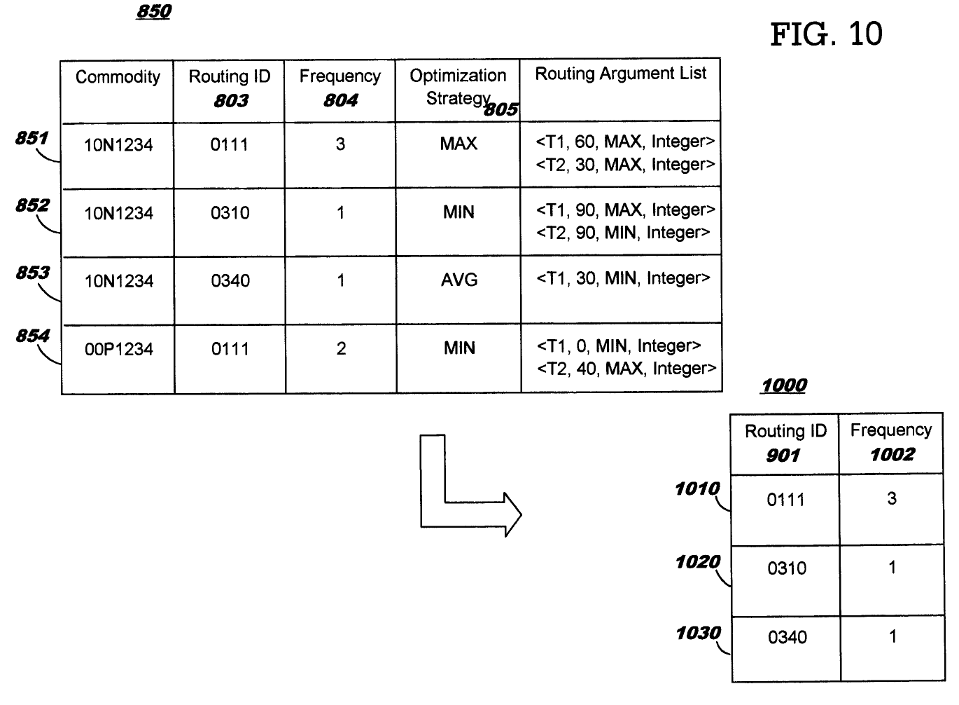

Referring to FIG. 10, the processing of Block 720 is illustrated therein. Using columns 804, 805 of interim data structure 850 of FIG. 8, an augmented form of data structure 900 is created by Block 720 of FIG. 7. This augmented data structure is illustrated as output table 1000. This output table contains the routing identifiers 901 from table 900, along with a frequency value 1002 for each of those routing identifiers, where this frequency value is determined as will now be described with reference to the sample data.

Referring to column 804 of table 850, it can be seen that the frequency values for the 4 rows of this table are 3, 1, 1, and 2. For the particular routing identifier “0111” (see column 803), table 850 specifies 2 different frequency values, namely 3 in row 851 and 2 in row 854. Accordingly, a conflict exists as to whether the process having routing identifier 0111 is to be performed 3 times or 2 times. The optimization strategy values in column 805 of table 850 are therefore used to resolve this conflict. The optimization strategy value in row 851 is “MAX”, and the optimization strategy value in row 854 is “MIN”. When taken together with the frequency values from column 804 of rows 851 and 854, this information indicates that the process identified using routing identifier 0111 is to be performed a maximum of 3 times, and a minimum of 2 times, on this collection of commodities. Notably, current industry practice would perform the routing 5 times-that is, 3 times according to row 851, and 2 times according to row 854.

Using the frequency 804 and optimization strategy 805 values from table 850, Block 720 accesses a frequency optimization strategy precedence table, such as table 500 of FIG. 5, to resolve the conflict in how many times to perform the 0111 routing for the commodities of the group. Table 500 indicates that an optimization strategy of “MAX” has a higher precedence than an optimization strategy of “MIN”. Accordingly, row 851 takes precedence over row 854, and as a result, routing 0111 will be performed 3 times instead of 2 times. The frequency value of 3 is therefore inserted into the frequency column 1002 of the corresponding row 1010 (i.e., the row for routing identifier 0111) of table 1000.

No conflicts are found for the frequency of performing the routings having identifiers “0310” and “0340”, which correspond to rows 852, 853 of table 850. The frequency values from column 804 of rows 852, 853 are therefore copied directly into the frequency column 1002 of corresponding rows 1020, 1030 of data structure 1000 in FIG. 10.

Block 730 uses the commodity routing information created by Block 700, and generates set of routing argument lists for each of the routings which are to be performed on the group of commodities.

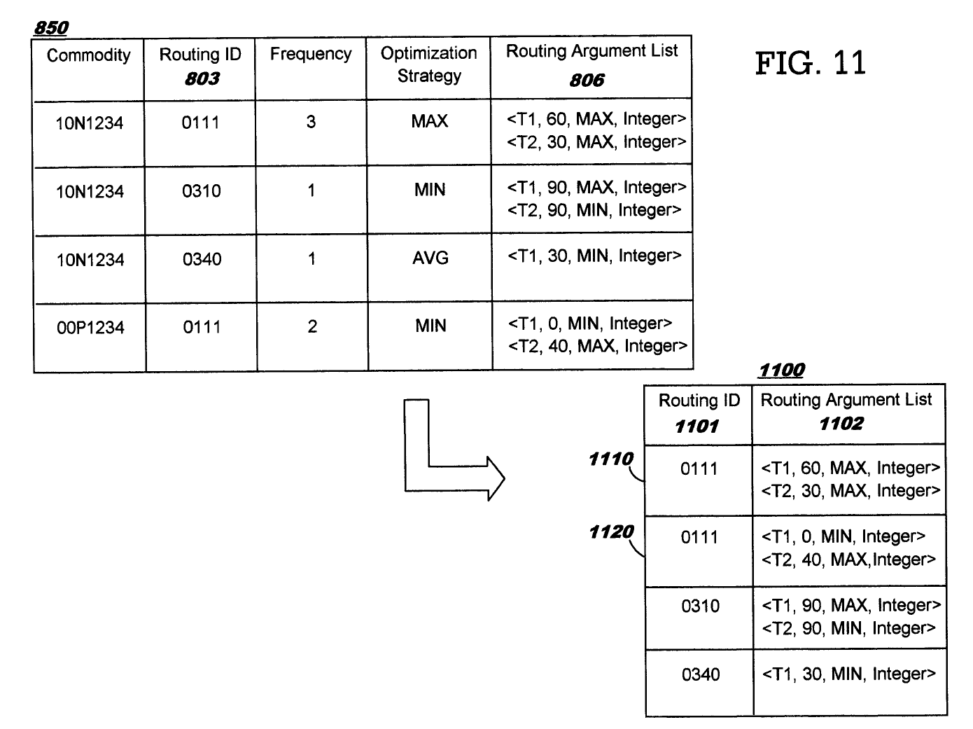

Referring now to FIG. 11, the processing of Block 730 is illustrated therein. In FIG. 11, the interim data structure 850 from FIG. 8 is shown as an input, and another data structure 1100 is shown as an output. Table 1100 comprises a collection of routing identifiers 1101, representing each of the values from column 803 of interim data structure 850. Note that repeated occurrences of routing identifiers are not removed when creating table 1100; see rows 1110 and 1120, for example. Table 1100 also comprises a routing argument list column 1102, and the entries in this column 1102 are preferably copied from column 806 of the rows of table 850.

Referring again to FIG. 7, Block 740 optimizes the shared routings, using as input the argument list entries that are output from Block 730 along with the argument list optimization strategy precedence table (an example of which was discussed above with reference to table 600 in FIG. 6), if needed to resolve conflicts. An output of Block 740 is an optimized collection of common routings.

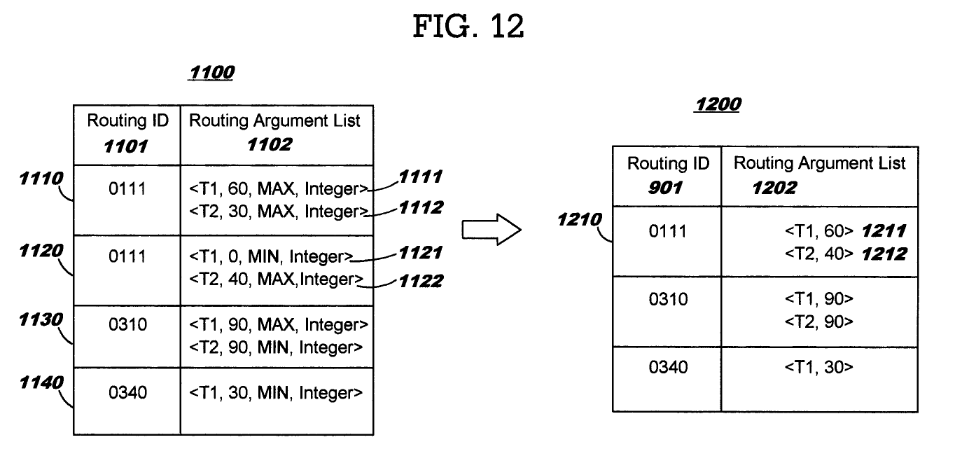

Referring to FIG. 12, the processing of Block 740 is illustrated therein. In FIG. 12, the data structure 1100 from FIG. 11 is shown as an input, and another data structure 1200 is shown as an output. Table 1200 may be generated as an augmented version of table 900 of FIG. 9, comprising a collection of the distinct routing identifiers (see column 901 of table 1200) from input data structure 1100. Table 1200 also comprises a routing argument list column 1202, and the entries in this column 1202 are created from entries in column 1102 of the rows of table 1100 by optimization of the argument lists for any common routing identifiers, as will now be described with reference to the sample data.

In the sample data of table 1100, routing identifier “0111” occurs in row 1110 and also in row 1120. An embodiment of the present invention therefore performs an optimization of the routing argument lists in those rows 1110, 1120. The occurrence of a routing identifier in column 1101 of table 1100 multiple times indicates that the manufacturing operation associated with this routing identifier is to be performed for the collection of commodities, and is applicable to 2 different subgroups of the commodities in that collection. (See rows 810 and 840 of table 800, for this example, which indicate that the 2 routing entries 1110, 1120 originated with commodities “10N1234” and “00P1234”.) Each of these different subgroups of the commodities may need the operation associated with routing identifier 0111 to be applied in different ways, and Block 740 therefore optimizes the routing so that the operation will be applied in an optimized manner. In particular, in contrast to known industry practices where the operation is applied without regard to potential redundancy or requirements of disparate commodities, an embodiment of the present invention accounts for these factors (including processing that may have already been performed).

In an embodiment of the present invention, each argument within the routing argument lists is optimized independently. In the example rows 1110 and 1120 in which the routing arguments lists are to be optimized, “T1” has an associated optimization strategy of “MAX” in argument list 1111 and an associated optimization strategy of “MIN” for argument list 1121. In the sample data, T1 is an argument representing a time length for performing a test, and argument list 1111 indicates that this test is to be performed for a maximum of 60 minutes, whereas argument list 1121 indicates that this test is to be performed for a minimum of 30 minutes. Block 740 accesses an argument list optimization strategy precedence table, such as table 600 of FIG. 6, to resolve the conflict in the argument lists. In the sample argument lists using T1, resolving the conflict comprises determining how long to perform the corresponding test.

The argument lists 1111, 1121 further specify that an optimization strategy for “Integer” is to be used in resolving this conflict. Using the Integer data type as an index to column 601 of table 600 locates rows 610-630. The “MAX” value from argument list 1111 matches the optimization strategy keyword value in row 601 of table 600, and the “MIN” value from argument list 1121 matches the optimization strategy keyword value in row 602 of table 600. Because row 601 has a higher priority than row 602, in this example, the argument list 1111 that specifies MAX takes precedence over the argument list 1121 that specifies MIN. Because argument list 1111 takes precedence, the integer value 60 specified therein is therefore selected for resolving the conflict, and the integer value 0 specified in argument list 1121 is therefore ignored. The argument value of 60 is therefore used, along with its corresponding argument T1, for the routing argument list 1211 in column 1202 of the corresponding row 1210 of table 1200.

Rows 1110, 1120 of table 1100 also have a conflict in use of the “T2” argument, and that conflict is also resolved by Block 740. In this case, argument list 1112 and argument list 1122 both specify an optimization strategy keyword of “MAX”. Therefore, instead of ignoring the value specified in one of the argument lists as in the case of argument lists 1111 and 1121, the argument values from both argument lists 1112 and 1122 are considered when resolving the T2 conflict. In this example, argument list 1122 specifies a value of 40, which is greater than the value of 30 specified in argument list 1112. Accordingly, the value 40 is selected, and is used, along with the corresponding argument T2, for the routing argument list 1212. The resulting routing 1212 therefore indicates that operation T2 should be performed for 40 minutes for the commodities in the collection, which meets the requirements of those commodities whose original routing definition indicates a need for 40 minutes of this operation and also meets the requirements of those commodities whose original routing definition indicates a need for 30 minutes of this operation.

Note that when resolving the conflict for T2 in argument lists 1212, 1222, where both of these argument lists specify “MAX” as their optimization strategy, an integer comparison is performed that selects the “max” value between the choices of 40 and 30. In the general case, an algorithm may be invoked to determined which of multiple values should be used to resolve a conflict. If the values are non-numeric color names, for example, an algorithm associated with the argument may be invoked to choose one of the colors from the choices.

Argument list optimizations are not performed with regard to the arguments in rows 1130 or 1140 of FIG. 11, as the associated routing identifiers do not appear in any other routings for this collection of commodities and therefore there are no conflicts to be resolved.

Referring again to FIG. 7, Block 745 generates a complete routing list for the grouped commodities. An output of Block 745 is a dynamically-generated routing that considers requirements of multiple disparate commodities as well as previously-performed operations. This output routing specification may be provided to manufacturing (e.g., at Block 125 of FIG. 1, replacing table 120), to be used as a list of the manufacturing activities to be executed on the collection of commodities.

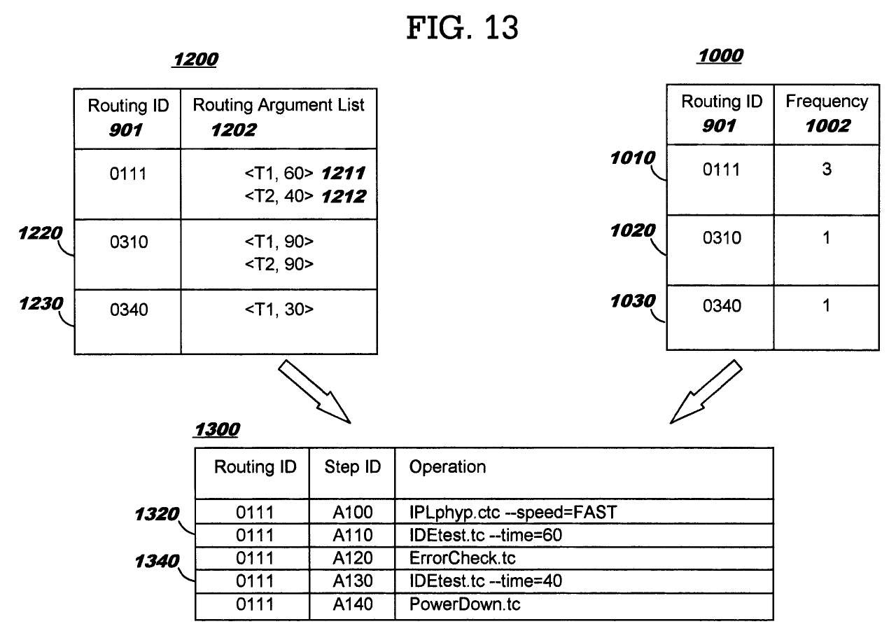

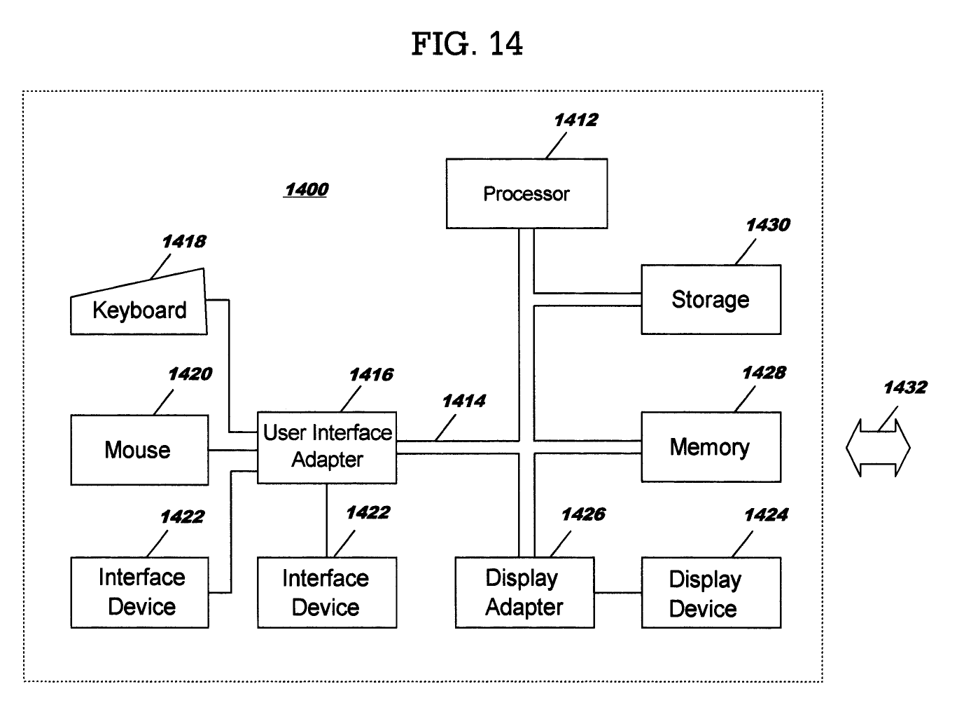

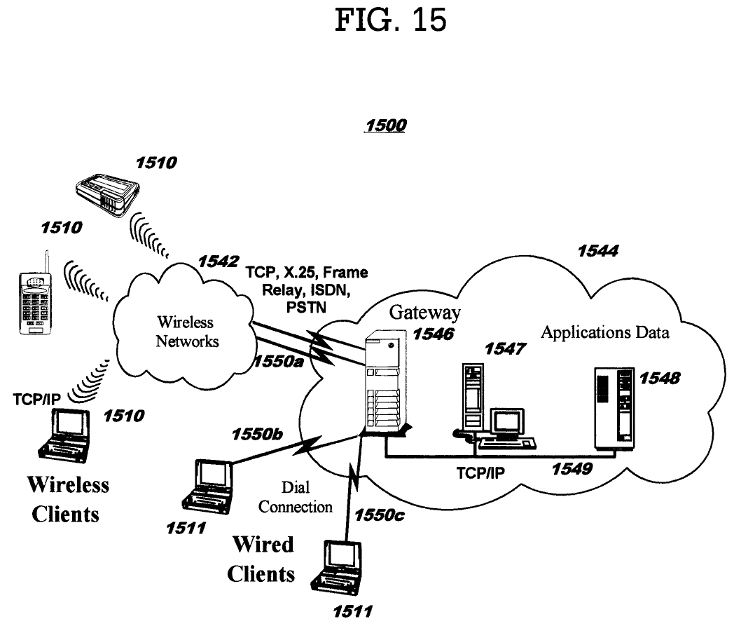

Referring to FIG. 13, the processing of Block 745 is illustrated therein. In FIG. 13, the optimized common routings in data structure 1200 (as created by Block 740) and the optimized frequencies in data structure 1000 (as created by Block 720) are shown as inputs. Routing definitions 750, which may be obtained from a routing definitions table such as table 300 of FIG. 3, are also shown in FIG. 7 as an input. Data structure 1300 is shown as an output, and may comprise an augmented version of the input 750.

Block 745 comprises applying the routing arguments and values from table 1200 and the routing frequencies 1002 from table 1000 to the routing definitions—that is, routing definition 300, in this example—to generate the complete routing list for the group of commodities. Accordingly, the entries in table 1300 represent an updated version of the entries from routing definition table 300 of FIG. 3 where the argument values—as optimized by Block 740—have been substituted for the arguments in the routing definitions. See row 1320, where the value 60 from routing argument list 1211 is substituted for (i.e., propagated to) argument T1, as shown in the “time=60” syntax of row 1320. See also row 1340, where the value 40 from routing argument list 1212 is substituted for argument T2, as shown in the “time=40” syntax of row 1340.

In the general case, any remaining arguments in the routing definition are propagated to the routing definition in an analogous manner to that which has been described for rows 1320 and 1340.

Use of frequency value “3” from column 1002 in row 1010 of table 1000 indicates that the 5 steps “A100” through “A140” of this particular routing are to be performed 3 times. Due to space constraints, the additional 2 copies of steps A100 through A140 have not been shown in table 1300 of FIG. 13. In addition, the steps as defined for routings 0310 and 0340 (see rows 1220, 1230 of table 1200) would also appear in the generated complete routing, although a depiction of those steps is not deemed necessary to an understanding of the present invention and they have therefore been omitted from the sample data (and the sample output table 1300). Each of those groups of steps would appear a single time in the generated complete routing 1300, as indicated by the corresponding frequency number in each of rows 1020, 1030 of table 1000.

As has been demonstrated, an embodiment of the present invention may reduce processing time for previously-processed commodities using techniques disclosed herein, and routings may be optimized with regard to overlapping requirements of multiple commodities to be processed as a group. At the same time, routings which are defined as being required for a particular commodity are included in the dynamically-generated routings for the group, ensuring that no required processes will be omitted. The disclosed techniques are scalable, and may be used in manufacturing environments that process a small number of different commodities as well as manufacturing environments that process a large number of different commodities. Routings are programmatically generated, as has been disclosed, and do not need to be manually determined for each group of commodities by a human operator. Efficiencies may also be realized by reusing routing definitions, for example using the above-described parameterization to adapt an already-specified routing definition to multiple commodities.

As will be appreciated by one of skill in the art, embodiments of the present invention may be provided as (for example) methods, systems, and/or computer program products. The invention can take the form of an entirely hardware embodiment, an entirely software embodiment, or an embodiment containing both hardware and software elements. In a preferred embodiment, the invention is implemented in software, which includes (but is not limited to) firmware, resident software, microcode, etc. Furthermore, the present invention may take the form of a computer program product which is embodied on one or more computer-usable storage media (including, but not limited to, disk storage, CD-ROM, optical storage, and so forth) having computer-usable program code embodied therein, where this computer program product may be used by or in connection with a computer or any instruction execution system. For purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (“RAM”), a read-only memory (“ROM”), a rigid magnetic disk, and an optical disk. Current examples of optical disks include compact disk read-only memory (“CD-ROM”), compact disk read/write (“CD-R/W”), and DVD.

Referring now to FIG. 6, a data processing system 600 suitable for storing and/or executing program code includes at least one processor 612 coupled directly or indirectly to memory elements through a system bus 614. The memory elements can include local memory 628 employed during actual execution of the program code, bulk storage 630, and cache memories (not shown) which provide temporary storage of at least some program code in order to reduce the number of times code must be retrieved from bulk storage during execution.

Input/output (“I/O”) devices (including but not limited to keyboards 618, displays 624, pointing devices 620, other interface devices 622, etc.) can be coupled to the system either directly or through intervening I/O controllers or adapters (616, 626).

Network adapters may also be coupled to the system to enable the data processing system to become coupled to other data processing systems or remote printers or storage devices through intervening private or public networks (as shown generally at 632). Modems, cable modem attachments, wireless adapters, and Ethernet cards are just a few of the currently-available types of network adapters.

FIG. 7 illustrates a data processing network environment 700 in which the present invention may be practiced. The data processing network 700 may include a plurality of individual networks, such as wireless network 742 and wired network 744. A plurality of wireless devices 710 may communicate over wireless network 742, and a plurality of wired devices, shown in the figure (by way of illustration) as workstations 711, may communicate over wired network 744. Additionally, as those skilled in the art will appreciate, one or more local area networks (“LANs”) may be included (not shown), where a LAN may comprise a plurality of devices coupled to a host processor.

Still referring to FIG. 7, the networks 742 and 744 may also include mainframe computers or servers, such as a gateway computer 746 or application server 747 (which may access a data repository 748). A gateway computer 746 serves as a point of entry into each network, such as network 744. The gateway 746 may be preferably coupled to another network 742 by means of a communications link 750a. The gateway 746 may also be directly coupled to one or more workstations 711 using a communications link 750b, 750c, and/or may be indirectly coupled to such devices. The gateway computer 746 may be implemented utilizing an Enterprise Systems Architecture/390® computer available from IBM. Depending on the application, a midrange computer, such as an Application System/400® (also known as an AS/400®), iSeries®, System i™, and so forth may be employed. (“Enterprise Systems Architecture/390”, “Application System/400”, “AS/400”, and “iSeries” are registered trademarks of IBM in the United States, other countries, or both, and “System i” is a trademark of IBM.)

The gateway computer 746 may also be coupled 749 to a storage device (such as data repository 748).

Those skilled in the art will appreciate that the gateway computer 746 may be located a great geographic distance from the network 742, and similarly, the wireless devices 710 and/or workstations 711 may be located some distance from the networks 742 and 744, respectively. For example, the network 742 may be located in California, while the gateway 746 may be located in Texas, and one or more of the workstations 711 may be located in Florida. The wireless devices 710 may connect to the wireless network 742 using a networking protocol such as the Transmission Control Protocol/Internet Protocol (“TCP/IP”) over a number of alternative connection media, such as cellular phone, radio frequency networks, satellite networks, etc. The wireless network 742 preferably connects to the gateway 746 using a network connection 750a such as TCP or User Datagram Protocol (“UDP”) over IP, X.25, Frame Relay, Integrated Services Digital Network (“ISDN”), Public Switched Telephone Network (“PSTN”), etc. The workstations 711 may connect directly to the gateway 746 using dial connections 750b or 750c. Further, the wireless network 742 and network 744 may connect to one or more other networks (not shown), in an analogous manner to that depicted in FIG. 7.

The present invention has been described with reference to flow diagrams and/or block diagrams according to embodiments of the invention. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a general purpose computer, special purpose computer, embedded processor, or other programmable data processing apparatus to produce a machine, such that the instructions, which execute via the processor of the computer or other programmable data processing apparatus, create means for implementing the functions specified in the flow diagram flow or flows and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flow diagram flow or flows and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flow diagram flow or flows and/or block diagram block or blocks.

While embodiments of the present invention have been described, additional variations and modifications in those embodiments may occur to those skilled in the art once they learn of the basic inventive concepts. Therefore, it is intended that the appended claims shall be construed to include the described embodiments and all such variations and modifications as fall within the spirit and scope of the invention.

1. A computer-implemented method of dynamically generating a routing specification for a plurality of commodities to be processed together, comprising:
for each of the commodities,
determining a current processing status thereof; and
using the determined current processing status and a commodity identifier associated with that one of the commodities to locate an associated routing definition, the associated routing definition specifying at least one process to be performed on that one of the commodities;
optimizing a collection comprising the specification of the at least process from each of the associated routing definitions; and
providing the optimized collection as the dynamically-generated routing specification for the plurality of commodities.

2. The method according to claim 1, wherein at least one of the commodities is a part.

3. The method according to claim 1, wherein at least one of the commodities is an assembly comprising a plurality of parts.

4. The method according to claim 1, wherein the current processing status indicates, for each of the commodities, any processes that have already been conducted on that commodity.

5. The method according to claim 1, wherein:
using the determined current processing status and a commodity identifier associated with that one of the commodities also locates a frequency with which the associated routing definition is to be performed; and
optimizing a collection further comprises detecting any conflicts among the located frequencies and resolving those detected conflicts, a conflict comprising a specification of a different value for the frequency when a particular one of the routing definitions is located more than once using the determined current processing status and a commodity identifier associated with that one of the commodities to also locate the frequency.

6. The method according to claim 5, wherein resolving those detected conflicts further comprises, for each detected conflict, programmatically selecting a particular one of the different values using a predetermined selection algorithm.

7. The method according to claim 1, wherein:
using the determined current processing status and a commodity identifier associated with that one of the commodities also locates an argument list for parameterizing the associated routing definition; and
optimizing a collection further comprises detecting any conflicts among the located argument lists and resolving those detected conflicts, a conflict comprising a specification of a different value for at least one argument in the argument list when a particular one of the routing definitions is located more than once using the determined current processing status and a commodity identifier associated with that one of the commodities to also locate the argument list.

8. The method according to claim 7, wherein resolving those detected conflicts further comprises, for each detected conflict, programmatically selecting a particular one of the different values using a predetermined selection algorithm.

9. A system for dynamically generating a routing specification for a plurality of commodities to be processed together, comprising:
a data repository storing a current processing status of each of the commodities;
a determiner for determining, for each of the commodities, the current processing status thereof as stored in the data repository and for using the determined current processing status and a commodity identifier associated with that one of the commodities to locate an associated routing definition, the associated routing definition specifying at least one process to be performed on that one of the commodities;
an optimizer for optimizing a collection comprising the specification of the at least process from each of the associated routing definitions; and
an output of the optimizer, comprising a specification of the optimized collection as the dynamically-generated routing specification for the plurality of commodities.

10. A computer-readable medium storing a computer program product for dynamically generating a routing specification for a plurality of commodities to be processed together, the computer program product comprising computer-readable program code for:
for each of the commodities,
determining a current processing status thereof; and
using the determined current processing status and a commodity identifier associated with that one of the commodities to locate an associated routing definition, the associated routing definition specifying at least one process to be performed on that one of the commodities;
optimizing a collection comprising the specification of the at least process from each of the associated routing definitions; and
providing the optimized collection as the dynamically-generated routing specification for the plurality of commodities.
